(19) United States
(12) Patent Application Publication
(10) Pub. No.: US 2023/0069869 A1
(43) Pub. Date: Mar. 9, 2023

(54) SELF-REINFORCED POLYMER STRUCTURES

(71) Applicant: Graham WILLIAMS, Portland, OR (US)

(72) Inventor: Graham WILLIAMS, Portland, OR (US)

(21) Appl. No.: 17/823,370

(22) Filed: Aug. 30, 2022

Related U.S. Application Data
(60) Provisional application No. 63/240,745, filed on Sep. 3, 2021.

(51) Int. Cl. B32B 27/12; B32B 5/02; B32B 7/12

(52) U.S. Cl. CPC B32B 27/12; B32B 5/024; B32B 7/12; B32B 2307/538; B32B 2307/31; B32B 2307/54; B32B 2307/72; B32B 2305/188

(57) ABSTRACT

A self-reinforced polymer adhered to a textile.

### CROSS-REFERENCE TO RELATED APPLICATIONS

This application claims the benefit of U.S. Provisional Patent Application No. 63/240,745 filed Sep. 3, 2021.

### BACKGROUND OF THE INVENTION

As industries such as aerospace, automotive, construction, and military containers, there is increased demand for lighter and lighter polymer composites and particularly thermoplastic composites. This trend is due to the composites offering high performance materials with minimal weight and increased weather resistance in comparison with metal material, such as high strength steels. Moreover, thermoplastic composites tend to be difficult to model for fatigue. Other types of relatively lightweight material include “carbon fiber” which are thermoset.

Moreover, some of the thermoplastic and/or thermoset materials are suitable for being re-melted and re-molded into new components which is not possible with the inclusion of fibers such as glass or carbon as such materials cannot be melted own. Also, polyethylene terephthalate which is a thermosetting material is often combined with thermoplastic resin to create thermoplastic polyethylene terephthalate that is suitable to be shredded and used for lower performance reinforced polymer composites.

Self-reinforced polymer composites (e.g., self-reinforced plastics and single polymer composites), are fiber reinforced composite materials. The fiber reinforcement in the materials is highly oriented version of the same polymer from which the matrix is made.

Self-reinforced polymer composites are manufactured from a variety of different thermoplastic polymers such as polyamide, polyethylene, polyethylene terephthalate, ultra-high density polyethylene, ultra-high density, ultra-high-molecular-weight polyethylene (e.g., Endumax, Spectra, Dyneema), aramid, and polypropylene (e.g., Tegris, Curv, Paua, Pure), and also thermoset or thermoplastic. Thermoplastic permits re-bonding if any delamination commences and an ad hoc repair.

Stiffness is a property which is augmented as a result of turning a material into a self-reinforced polymer composite. Strength, heat deflection temperature, and impact performance are all increased while offering little increase in the density of the material. The increase in impact performance is due to interfacial failure between the polymer tapes/fibers and the matrix material around them. This is a failure mechanism which does not exist in virgin unreinforced polymers as obviously there are no tapes/fibers and no interfacial bonds. As with all fiber reinforced composites, these materials gain their properties by transferring loads from the relatively low property matrix material into the high performance reinforcement fibers. Due to the very high level of molecular orientation within the reinforcements of self-reinforced polymer composites resulting from high draw ratios (up to 20 or more for polypropylene), the tape/fiber reinforcement within these materials has vastly higher properties than the unmodified material. Due to this, more traditional failure mechanisms such as tensile failure are delayed due to the transmission of load from the matrix to the tape/fiber reinforcement.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a self-reinforced polymer composite.

FIG. 2 illustrates another self-reinforced polymer composite.

FIG. 3 illustrates a textile.

FIG. 4 illustrates a sheet of self-reinforced polymer.

FIG. 5 illustrates a sheet of self-reinforced polymer, an adhesive film, and a textile.

FIG. 6 illustrates partially covered adhered stack of a sheet of self-reinforced polymer, an adhesive film, and a textile.

FIG. 7 illustrates a bag and a combination of fabric and SRP material.

FIG. 8 illustrates a hinge formed of fabric and SRP material.

FIG. 9A illustrates three military bags/pouches with webbing.

FIG. 9B illustrates the rear of the military bag/pouch of FIG. 9A with webbing.

FIG. 9C illustrates another military bag with webbing and hook material.

FIG. 10 illustrates a pouch attachment ladder system (PALS).

FIG. 11 illustrates a backpack with a PALS system and a bag.

FIG. 12 illustrates the backpack with a PALS system and a bag of FIG. 11.

FIG.13 illustrates the backpack with a PALS system and a bag of FIG. 11.

FIG.14A illustrates a face of an insert with slits.

FIG. 14B illustrates a close of a portion of the face of an insert with slits of FIG. 14A.

FIG. 15 illustrates an opposing face of the insert with slits of FIG. 14A.

FIG. 16 illustrates a face of an insert with webbing arranged consistent with the PALS system.

FIG. 17 illustrates an opposing face of the insert with webbing of FIG. 16.

FIG. 18 illustrates a misalignment of the spacing of the edges of FIG. 16 and FIG. 14A.

FIG. 19 illustrates an insert with spaced apart pairs of slits having different spacings.

FIG. 20 illustrates the reverse of FIG. 19 of the insert with different spacings.

FIG. 21 illustrates an insert to accommodate snaps.

FIG. 22 illustrates a close up the insert to accommodate snaps of FIG. 21.

FIG. 23 illustrates a medical pouch.

FIG. 24 illustrates another medical pouch.

FIG. 25 illustrates an organizational interior of an insert sized to fit within a medical pouch.

FIG. 26 illustrates an insert within the medical pouch of FIG. 25.

FIG. 27 illustrates an insert within the medical pouch of FIG. 25.

FIG. 28 illustrates an exterior of medical backpack with PALS compliant webbing, additional webbing, and hook fabric.

FIG. 29 illustrates the interior of medical backpack of FIG. 28 with a removable multitude of compartments.

FIG. 30 illustrates an interior of a medical backpack with four attachment pouches.

FIG. 31 illustrates an interior of a medical backpack with one attachment pouch secured thereto of FIG. 30.

FIG. 32 illustrates an interior of a medical backpack with two attachment pouches secured thereto of FIG. 30.

FIG. 33 illustrates an interior of a medical backpack with three attachment pouches secured thereto of FIG. 30.

FIG. 34 illustrates an exterior of the medical backpack of FIG. 30.

FIG. 35 illustrates a medical backpack.

FIG. 36 illustrates a side of an insert for a backpack.

FIG. 37 illustrates an opposing side of the insert for the backpack of FIG. 36.

FIG. 38 illustrates the insert of FIG. 36 folded in a “U” shape.

FIG. 39 illustrates a panel supported by a user.

FIG. 40 illustrates another panel supported by a user.

### DETAILED DESCRIPTION

Referring to FIG. 1, one manner of manufacturing the SRP composites includes hot compaction. Hot Compaction is a method by which highly oriented polymer tapes are accurately heated. This heating allows approximately 10% (e.g., 5-15%) of the polymer tapes to melt. With the application of pressure this molten polymer flows throughout the lattice work of tapes to form a continuous matrix. The sheet is then cooled while still under pressure to solidify the matrix. This process results in a rigid sheet which can then be thermoformed.

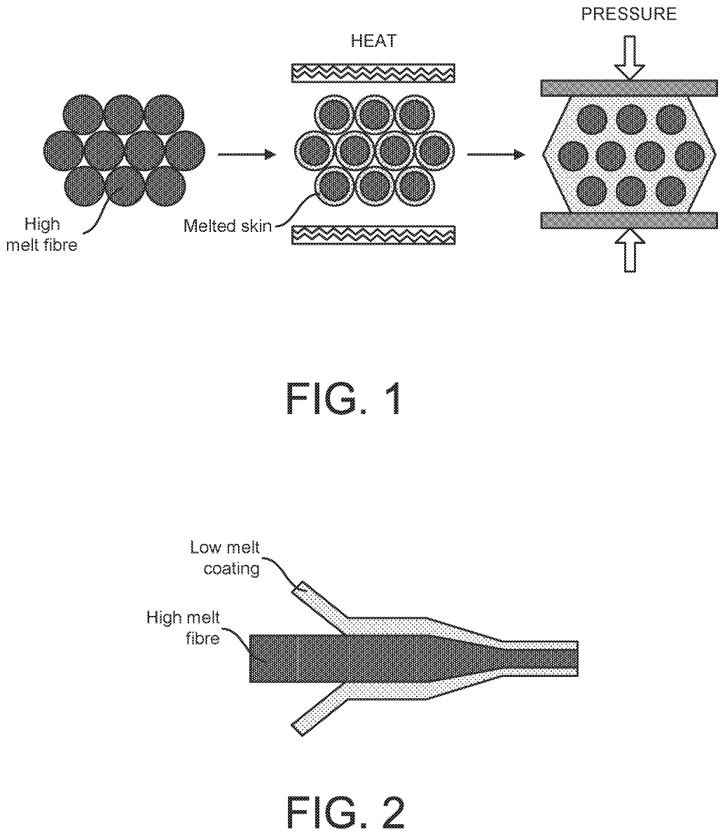

Referring to FIG. 2, another manner of manufacturing the SRP composites includes co-extrusion. Highly oriented polymer tapes are extruded from a high melting point grade of the chosen polymer. During this process a low melting point grade of the same family of polymers is extruded on the surface of the tape. These tapes can then be woven to form a fabric. During post processing into shaped components the outer layer melts before the inner core of oriented polymer. Under pressure this low melt grade flows throughout the fabric. On cooling this low melt grade of polymer re-solidifies to form the composite matrix.

Other techniques may be used to form SRP component fiber, SRP composite, and/or SRP fabrics.

One type of preferred SRP material includes a woven thermoplastic composite material, of a tape yarn construction, that provides impact resistance and stiffness while having a light weight. Some types of self-reinforced composites and/or polymers may use other types of construction, including for example, crystal extrusions, and traditional thread. The woven thermoplastic composite material of a tape yard construction preferably includes a multi-layer construction, with an outer layer preferably having a melt point at a lower temperature than a core material sandwiched therein. The multiple layers of the fabric are stacked together and heat and pressure are applied to form a substantially rigid, impact resistant, material. For example, a homogenous glue may be coated on a fiber or tape, and then the fiber or tape is woven together, and then the layers of the fabric are com posited through heat and pressure. Some types of the material, for example, may be constructed from a tape with a tensile modulus of 10 GPa or more, a shrinkage at 130 degrees C. of 6% or less, a sealing temperature of 120 degrees C. or more, and/or a denier of 900 or more. A single layer of the fabric preferably has a thickness of less than 1.0 mm. In general, self-reinforced polymeric materials (e.g., self-reinforced composite fabric) may be used, which may include one or more components, with the spatial alignment of the reinforcing phase in the matrix in 1D, 2D, or 3D.

By way of example, the woven thermoplastic composite material may start out a series of polypropylene (PP) films that form a tape yarn within a polymer matrix—for composite processing—before being woven into fabric. This is then pressed under heat and pressure to form a single piece approximately 0.005 inch (0.13 mm) that weighs just 0.02 lbs/sq.ft (0.11 kg/sq.m). Multiple layers are added depending on the desired thickness. The multi-layers are melted together. From there, the sheet can be formed into a variety of shapes using heat and pressure, depending on the mold. The end result contains no fragment-producing glass, unlike carbon fiber or various glass type structures, has high impact resistance and retains strength from around +180 degrees F. down to −40 degrees F.

By way of example, the self-reinforced composite materials may include a density (kg/m3) of greater than 800, and more preferably greater than 900. By way of example, the self-reinforced composite materials may include a tensile modulus (GPa) between 3 and 35, and more preferably between 3 and 30. By way of example, the self-reinforced composite materials may include a tensile strength (MPa) of greater than 100, and more preferably greater than 125, and less than 500, and more preferably less than 400. By way of example, the self-reinforced composite materials may include an edgewise notched Izod impact strength at 20 degrees C. (J/m) of greater than 100 and less than 6000, and more preferably greater than 1250 and less than 5000. Also, hybrid SRC composite materials together with carbon or ultra-high molecular weight polyethylene (e.g., 3 to 8 million amu) may be used. By way of example, the UHMWPE powder grade GUR 4120 (molecular weight of approximately 5.0×106 g/mol) may be used to produce an isotropic part of the multilayered sample. The powder may be heated up to 180° C. at a pressure of 25 MPa in a mold to produce 80×10×2 mm3 rectangular samples, with fibers having an average diameter of 15 μm (e.g., 10-20 μm) and a linear density of 220 Dtex (e.g., 150-300 Dtex).

By way of example, Tegris thermoplastic composites (i.e., SRP) provide impact resistance and stiffness using three polymer layers in an ABA construction. The outer, or “A” layer melts at a lower temperature than the core “B” layer. To consolidate, multiple layers of fabric are stacked together and heat and pressure is applied to form a rigid, impact resistant material. For example, for the tape the tensile modulus is typically 14.0 GPa or more, the shrinkage (130 degrees C.) is less than 5.5%, the sealing temperature is 130 degrees C., and the denier is 1020 or more. For example, for the fabric the tensile has a peak load N of 720 or more, a peak load lbf of 160 or more, and an elongation at break (%) of 7.8 percent or less. The consolidated sheet typically has a bulk density of 0.78 or less, a thickness of 0.125 mm/layer, a tensile strength MPa of 200 or more, a modulus GPa of 5-6, an elongation at break % of 6 or more, and a flexural modulus GPA of 5-6.

The ability to join different components together is fundamental to the assembly of systems from multiple components. Unfortunately, it is known to be problematic to use adhesives to securely secure different SRP components together, which is believed to be primarily due to low surface free energy of the SRP component. This limitation is even more acute of an issue when attempting to securely adhere a fabric/textile to the SRP component.

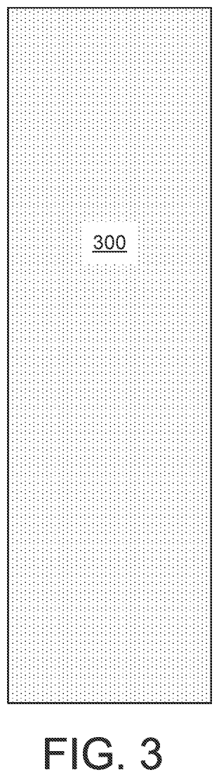

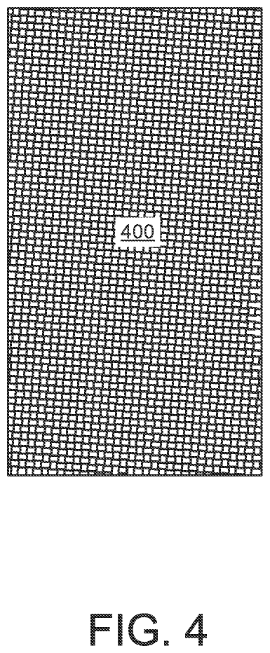

Referring to FIG. 3, to overcome the limitations of adhesives, fabric 300 may be secured to the SRP material 400 by sewing through the material stacked together with a strong thread around the perimeter of the SRP material and typically in a Box-X or checkerboard pattern across the face of the material to maintain the fabric generally close to the SRP material in areas proximate the thread. Unfortunately, even with a relatively dense pattern of the checkerboard sewing pattern, the fabric material is not securely maintained in place across its face. When using one of hook and loop fabrics (e.g., Velcro) secured to the SRP material (typically the loop), the other of the hook and loop is secured to a bag or other item (typically the hook), with the pair of fabrics being pressed together to form a connection. With the fabric only secured to the SRP material along the thread lines, the bag or other item will tend to sag and not be maintained in a secure location. Further, the thread tends to be heavy (e.g., T90 or Tex90 bonded nylon thread) further weighing down the SRP material and fabric combination.

While a coating may be adhered to the SRP material, it is more preferable to directly adhere a fabric to the SRP material in a manner that provides a durable and a sufficiently strong bond. In general, it is desirable to adhere textiles to the SRP material, such as fabrics including woven and non-woven (films) fabrics, knit fabrics, veils, and/or scrims. By way of example, such textiles may be made from polyamide, polyester, polypropylene, polyethylene, Ultra HMWPE, etc.

With the surface energy of the SRP material being sufficiently low making it difficult to suitably adhere textiles to its surface, the surface of the SRP material may be optionally mechanically roughened and/or chemically treated to increase its surface energy. The treatment may include a chemical treatment, which in addition to removing containments, increases the surface energy of the SRP material. An alcohol based product or a methyl ethyl ketone (C4H8O or CH3COCH2CH3) may be applied, such as using a roller, sponge, cloth, or drawn through a chemical bath. The chemical treatment is then allowed a sufficient time to try prior to adhering a textile to its surface.

With the surface energy of the SRP material being sufficiently low making it difficult to suitably adhere textiles to its surface, the surface of the SRP material may be optionally treated to increase its surface energy. The treatment may further or alternatively include a corona treatment (e.g., air plasma and/or flame plasma) that receives a low temperature corona discharge plasma to impart changes in the properties of the surface. The corona treatment tends to increase the surface energy.

While the treatment of the surface of the SRP material tends to improve its ability to adhere to textiles, it is also desirable that the adhesive be in the form of a film, rather than a free flowing liquid, although a liquid may be used. The film tends to include an optimal matrix of adhesive that is flat, with predictable uniform characteristics, that may be trimmed to a suitable size. The film may include the same adhesive material on both sides or have one type of adhesive on its first side and another type of adhesive on its second side. With different types of adhesives on each of the sides of the film, the film may be especially suitable for adhering to the SRP material on one side and especially suitable for adhering to the textile on its other side. By way of example, the film may be initially adhered to either the textile or the SRP material, then the combination of which is adhered to the other of the textile or the SRP material. Preferably, due to the temperature gradient between the SRP material (e.g., 230 degrees C.) and the fabric material (e.g., 150 degrees C.), the film is adhered to the SRP material, and then the combination is adhered to the fabric. Alternatively, a sandwich structure may be formed and the stack of the SRP material, the film, and the textile may be adhered at the same time using a roller lamination machine or a heat press.

While the use of the surface treatment to the SRP material, if used, tends to improve the adherence characteristics of the SRP material, and the use of a film, if used, further tends to improve the adherence characteristics of the SRP material, the selection of the particular type of adhesive results in a sufficiently secure bond. Upon further reflection, it was determined that SRP materials are constructed from one of several different base materials, such as polyamide, polyethylene/UHMWPE, or polypropylene. To form a sufficiently strong adhesive bond to the SRP material, it was determined that the characteristics of the film should match that of the SRP material. For example, a polyamide based adhesive film should be used for SRP material having a polyamide base. For example, a polyethylene based adhesive film should be used for SRP material having a polyethylene base. For example, a polypropylene based adhesive film should be used for SRP material having a polypropylene base. Upon further reflection, it was determined that having similar chemical characteristics of the adhesive film and the SRP material, results in a sufficiently strong bond.

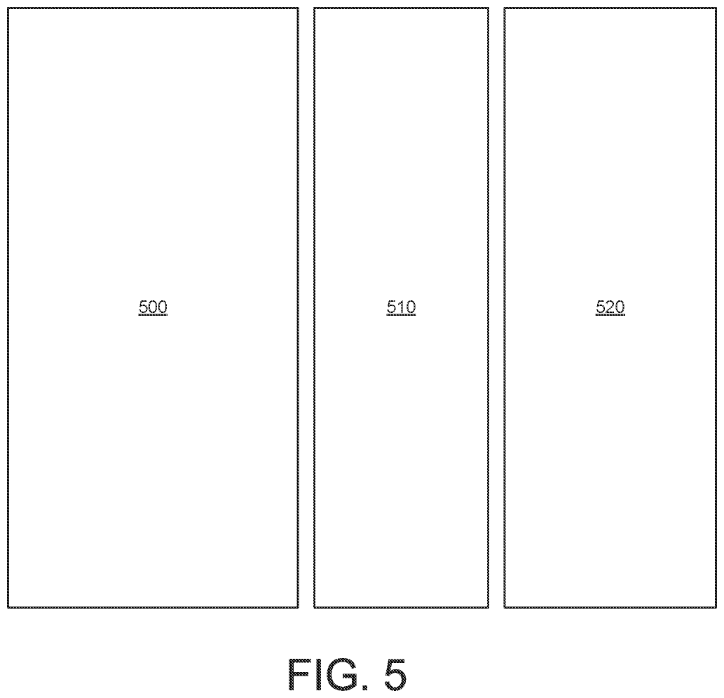

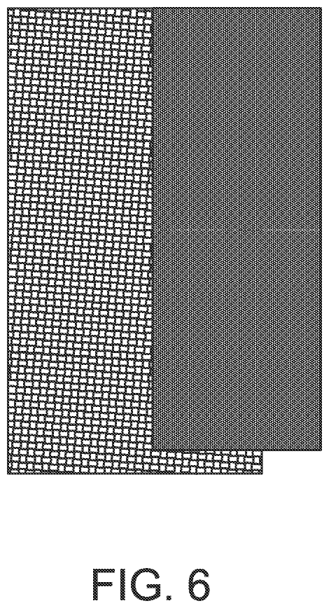

Referring to FIG. 5 and FIG. 6, a SRP material 500, a film 510, and a textile 520 are trimmed to an appropriate size, then the film 510 is used to adhere together the SRP material 500 to the textile 520, as illustrated in FIG. 6. As it may be observed, the textile is adhered to the SRP material across its entire surface, thereby maintaining a secure bond between the textile and the SRP material.

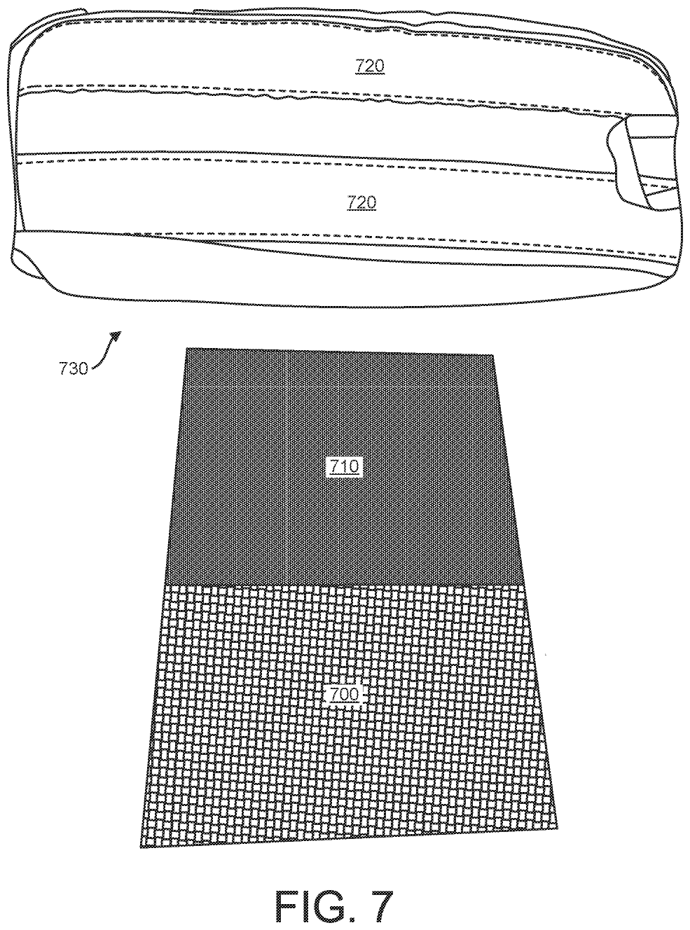

The textile 520 is preferably a loop fabric that is suitable for being detachably affixed to a hook fabric. Also, the loop fabric 520 is suitably affixed in a face-to-face manner with the SRP material. Referring to FIG. 7, as a result, the SRP materials 700 together with the loop fabric 710 may be used in combination with devices that also rely on a fabric material, such as military style bags, that includes hook fabric 720 on the exterior thereof. With the loop fabric 710 detachably connected to the hook fabric 720, the SRP material 700 may be maintained in a generally fixed location with the military style bag 730. In addition, the hook fabric has been included on bags for fly fishing, explosive articles, photographic equipment, avalanche safety gear, cosmetics, battlefield medical care, or otherwise.

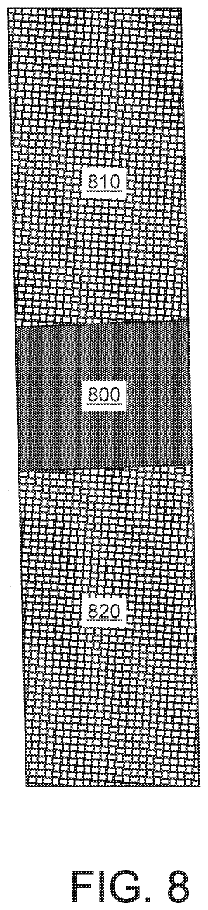

Referring to FIG. 8, a fabric material 800 may be used to interconnect two pieces of SRP material 810, 820 together. In this manner, the two pieces of SRP material 810, 820 may form a flexible hinge while making use of the improved characteristics of the SRP material on either side of the central portion of the fabric material.

Other configurations of the SRP material and fabric affixed to one another may be used. For example, a layered set of materials may include fabric, SRP material, and loop material. For example, a layered set of materials may include fabric, SRP material, fabric. For example, a layered set of materials may include loop material, SRP material, and loop material. For example, a layered set of materials may include hook material, SRP material, and loop material. For example, a layered set of materials may include hook material, SRP material, and hook material. For example, a layered set of materials may include hook material, SRP material, and fabric.

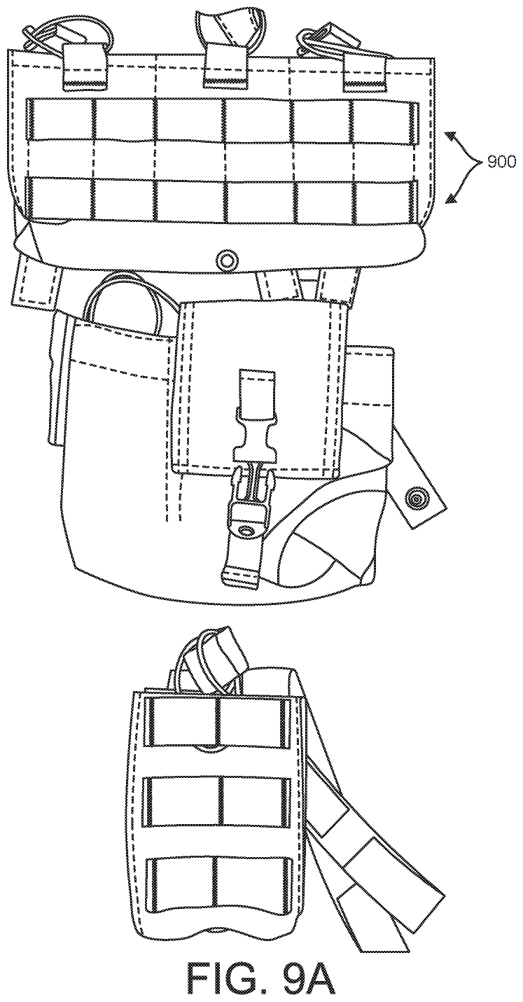

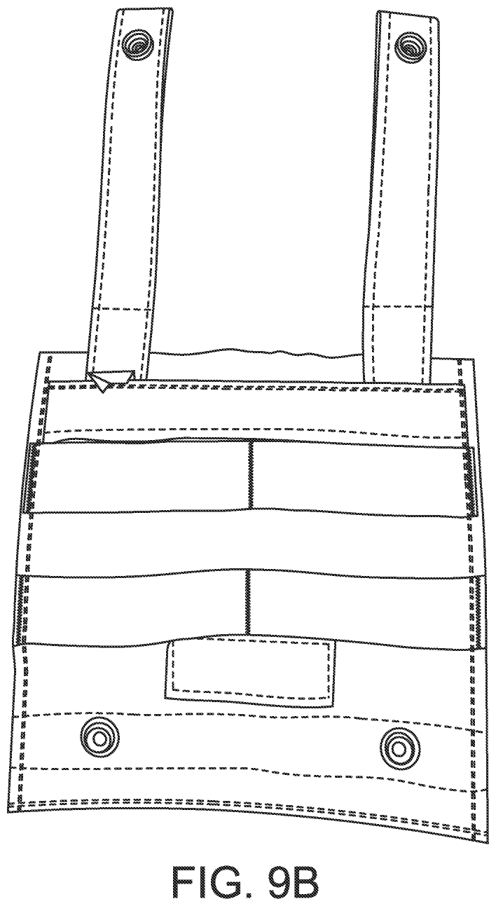

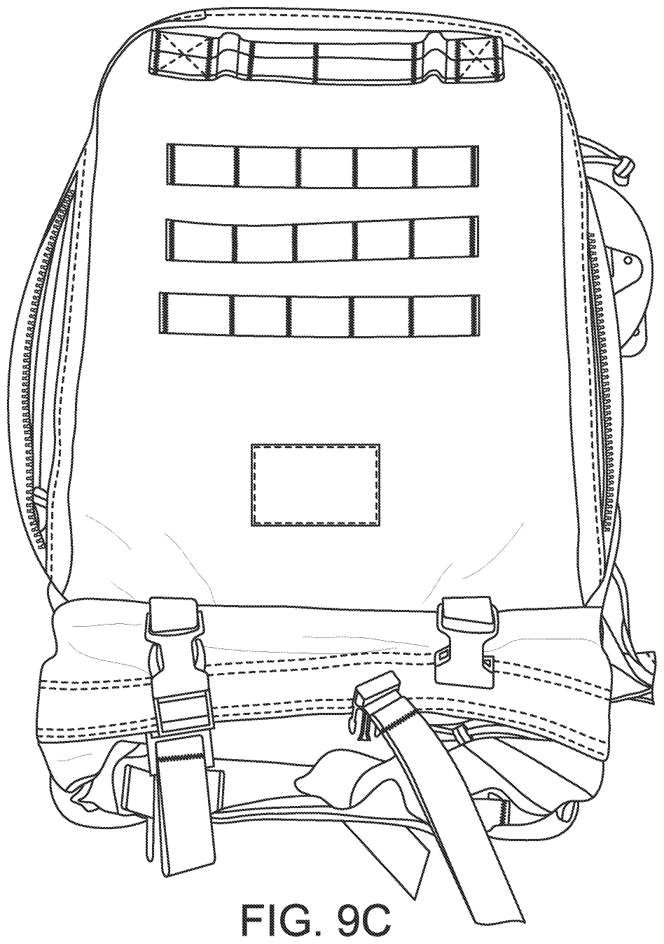

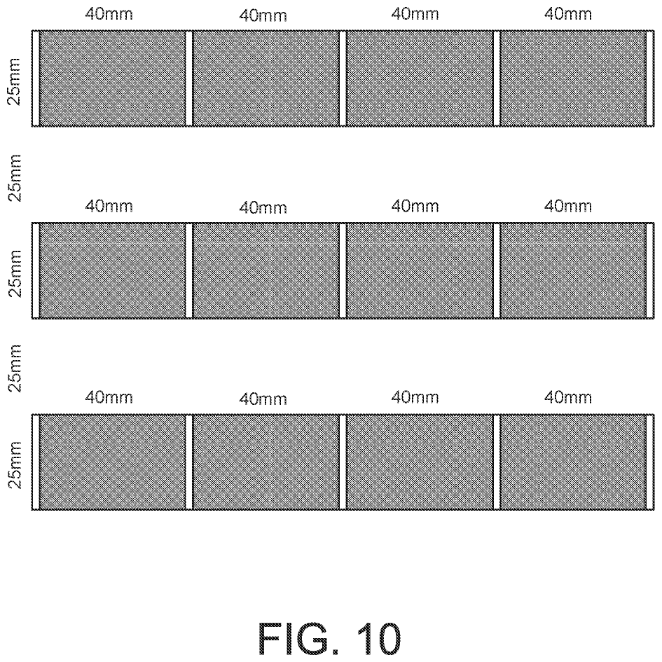

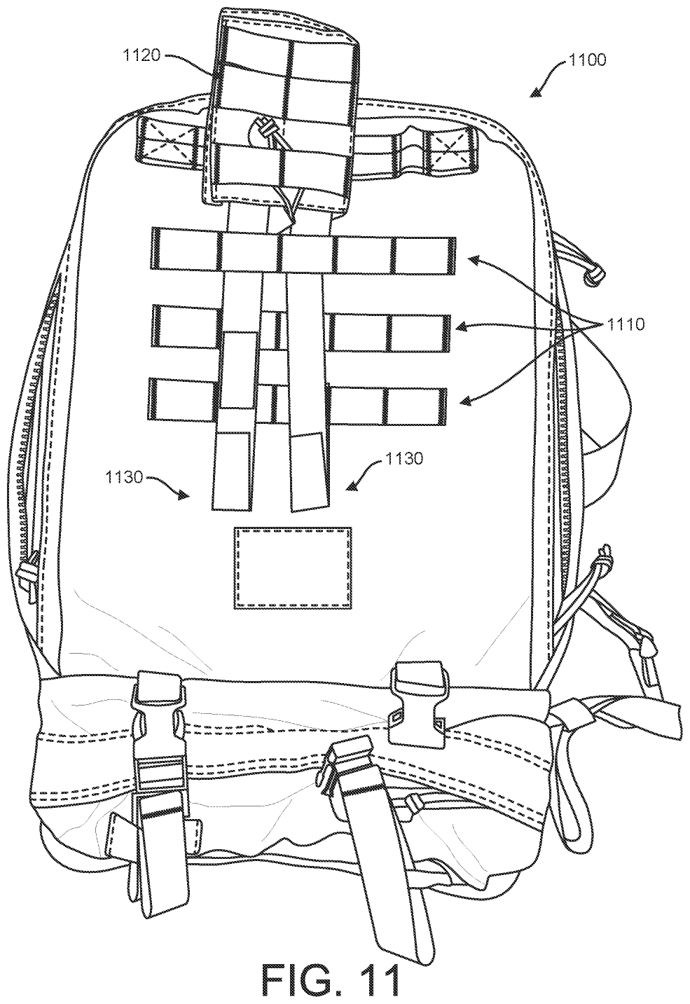

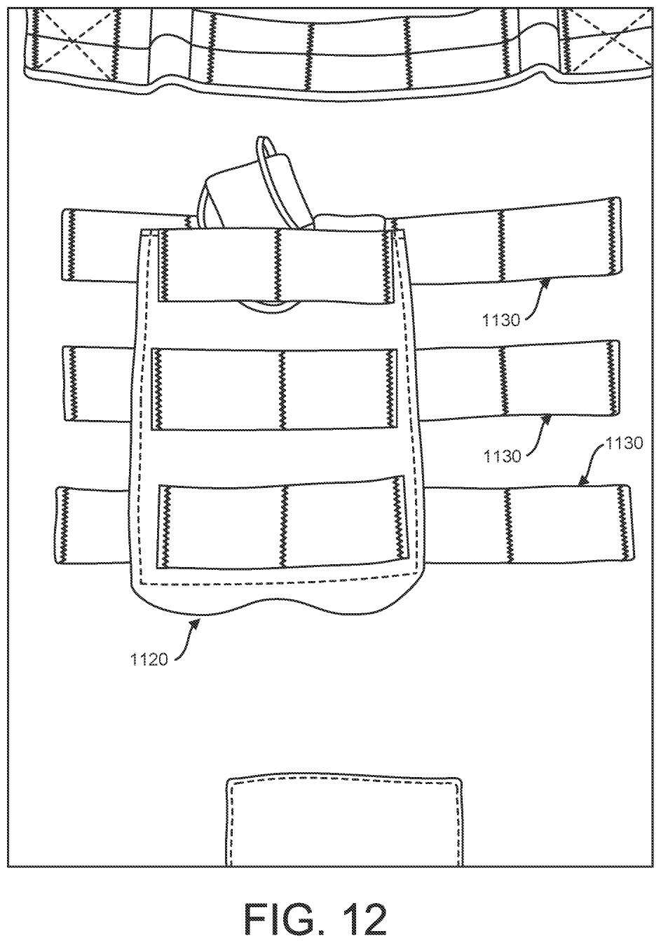

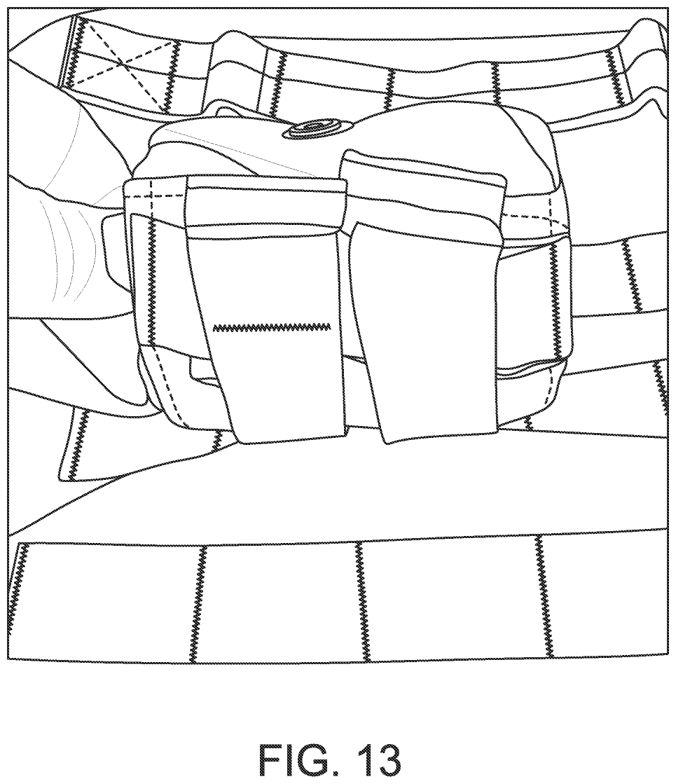

Referring to FIGS. 9A-9C, various types of military bags are shown. The bags include a fabric exterior together with a grid of webbing 900. By way of example, the grid of webbing 900 may confirm to the pouch attachment ladder system (PALS). Referring to FIG. 10, the PALS grid may, for example, consist of horizontal rows of 25 mm (1 inch) (e.g., 23-27 mm) webbing (e.g., nylon) which are attached to the backing at 38 mm (1.5 inch) (e.g., 35-40 mm) intervals. For example, the webbing may be 1 inch +/− 1/16^{th} of an inch. For example, the webbing may be 1 inch +11 3/64^{th} of an inch. For example, the webbing may be 0.038-0.050 inches in thickness or otherwise up to 0.210 inches in thickness. The resulting load bearing systems and subsystems that utilize the woven PALS webbing for modular pouch attachment is generally referred to as modular lightweight load-carrying equipment (MOLLE). Referring to FIG. 11, a resulting configuration is illustrated where a backpack 1100 that includes a PALS grid 1110 is affixed to a bag 1120 that includes webbing 1130 at a spaced apart location suitable for interconnection to the PALS grid 1110. Referring to FIG. 12 and FIG. 13, the resulting bag 1120 is illustrated secured to the PALS grid 1110.

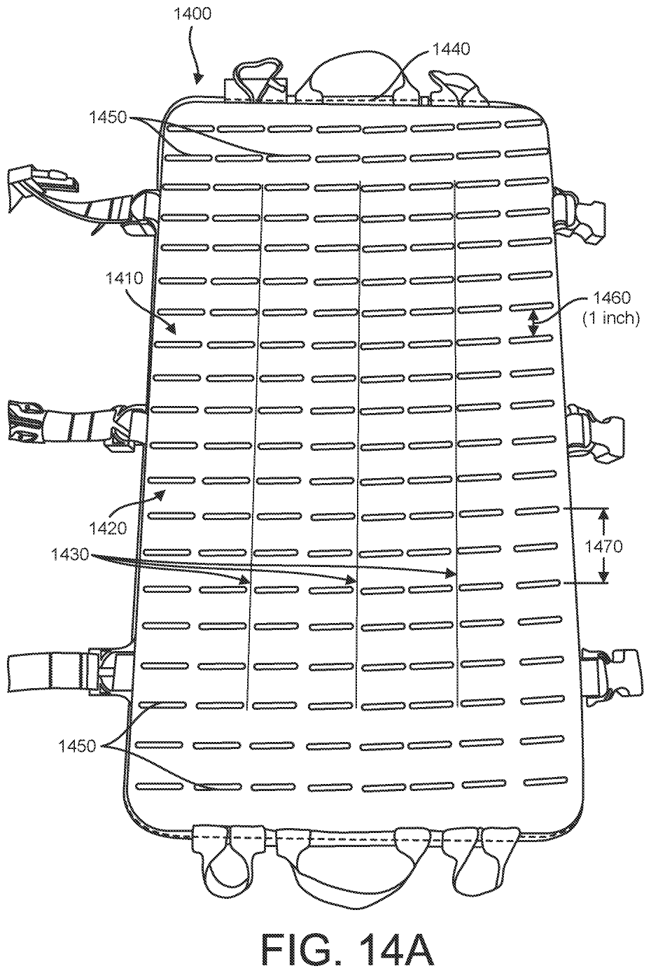

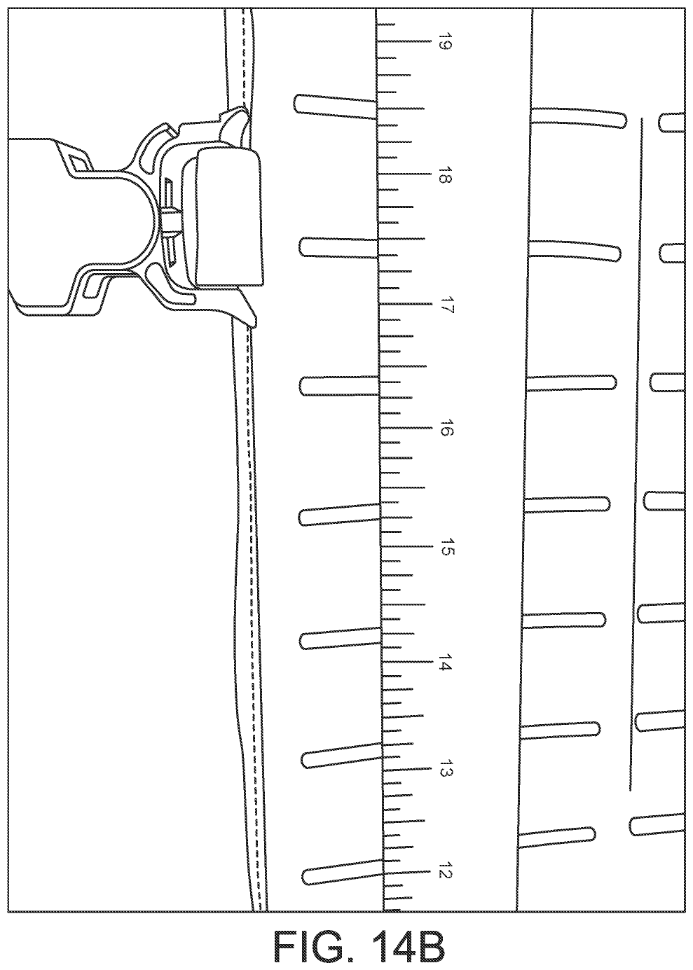

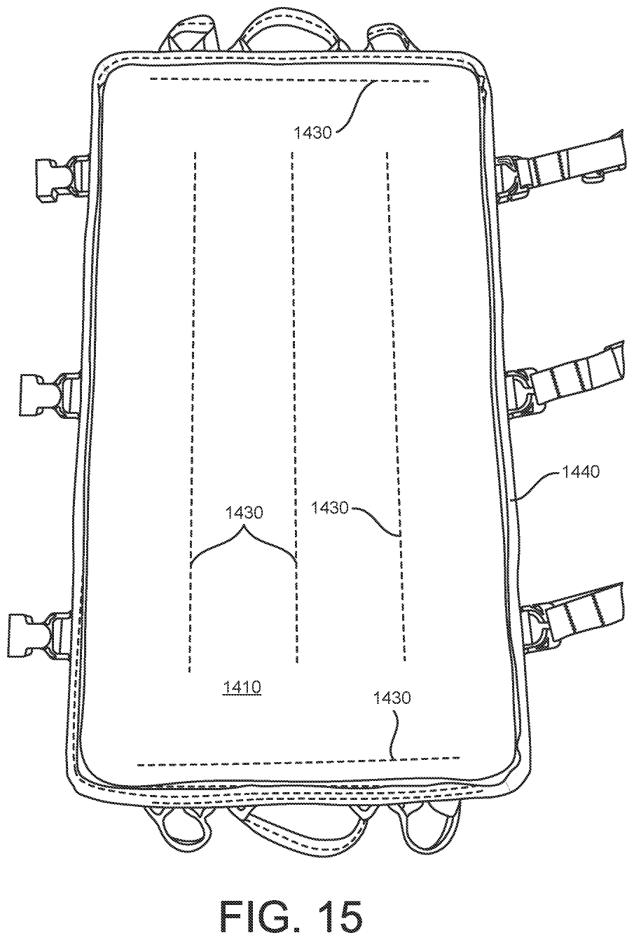

Referring to FIG. 14A, FIG. 14B, and FIG. 15, often there exists situations where bags, backpacks, or otherwise, use an insert 1400 that include a substantially rigid backing material 1410 (e.g., plastic) upon which is sewn a fabric 1420 using a pattern of threaded stiches 1430 and a sewn wrapping 1430 around the edges thereof. The surface of the fabric 1420 is not otherwise affixed to the backing material 1410 apart from the threaded stitches 1430 and the sewn wrapping 1440 around the edges. The fabric 1420 and backing material 1410 includes a series of co-located slits 1450 cut therein so that bags (e.g., see, FIG. 11, FIG. 12, FIG. 13) may be secured thereto. Unfortunately, the bag/pouch tends to move about on the insert 1400 due to the limited securing of the fabric 1420 to the backing material 1410 along sewn lines which results in substantial relative movement with respect to one another. Further, the use of a substantial amount of thread results in a relatively heady insert 1400. In addition, the spacing between the edges of adjacent rows of slits is 1 inch (e.g., 25 mm) 1460. The width of the slits are 0.25 inch (e.g., 6 mm). Also, it tends to be problematic to properly secure the straps of the bags to the insert in a secure and tight manner.

After further consideration it was determined that the slits of FIG. 14A, as measured by FIG. 14B, that are arranged with spacings of 25 mm are not arranged in accordance with the PALS configuration because the PALS configuration is based upon opposing edges of a 25 mm webbing securing a bag thereto which are spaced at 25 mm apart. For a pair of the closest edges of adjacent slits the spacing is 25 mm in accordance with the PALS configuration. However, for distances more than two adjacent slits, the spacing is greater than multiples of 25 mm. By way of example, the opposing edges of the slits of FIG. 14A for a triplet of slits (two slits with a slit therebetween) are arranged with a spacing greater than 25 mm times 2 (e.g., 50 mm) apart. In particular, the spacing 1470 between the slits is 25 mm plus the width of the central slit of 6 mm, for a total of 56 mm. The result of this is based upon a commonly held misunderstanding of needing 1 inch spacing between slits, as opposed to the securing edges being multiples of 1 inch spacing. Other materials may likewise be used, such as aluminum with slits, an aluminum plate, a steel plate, or other firm or flexible material.

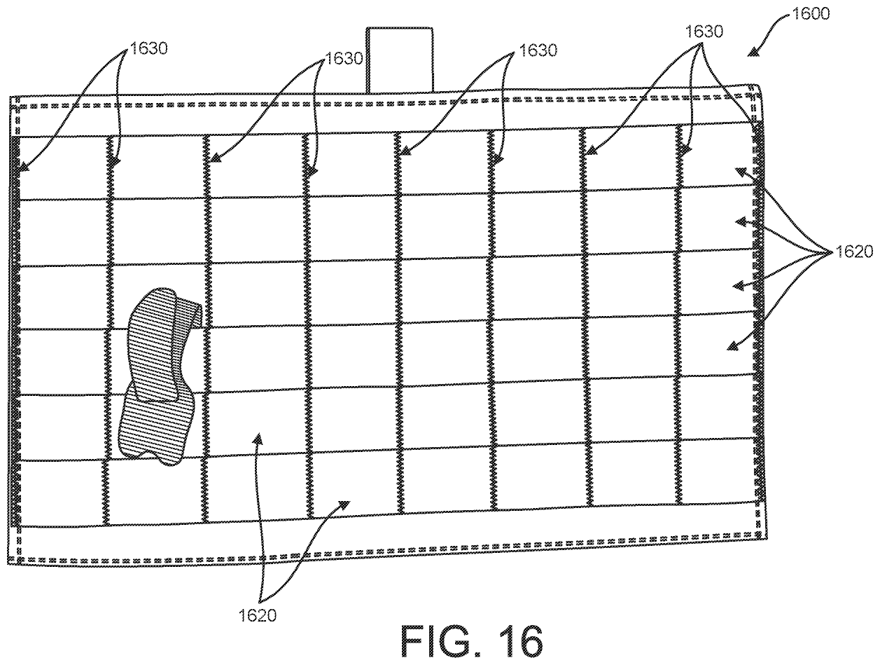

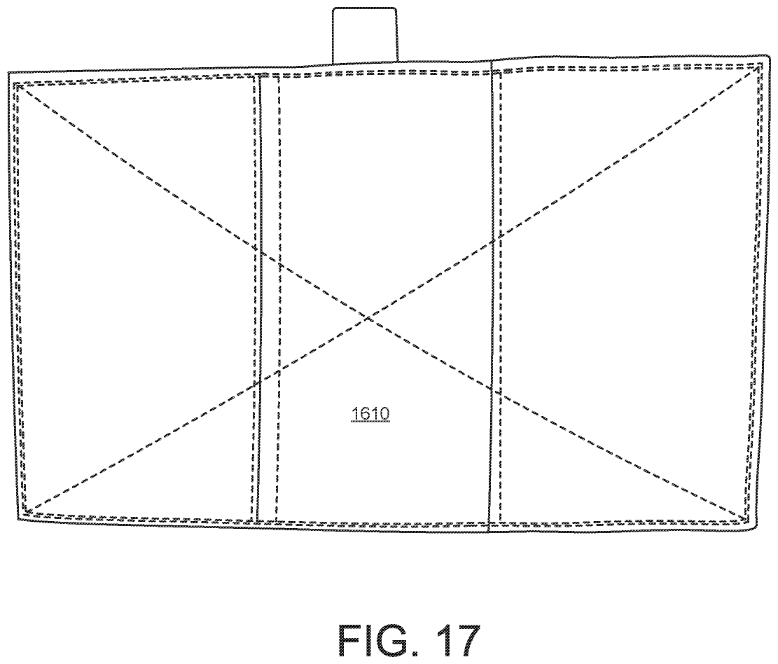

Referring to FIG. 16 and FIG. 17, an insert 1600 includes a substantially rigid backing material 1610 (e.g., plastic) upon which is sewn a series of 1 inch webbings 1620 with a pattern of threaded stiches 1630. The surface of the webbing 1620 is not otherwise affixed to the backing material 1610 apart from the threaded stitches 1630. With the edges of the 1 inch webbing abutting one another, the spacing between spaced apart edges of the webbing remain multiples of 1 inch, in accordance with the PALS configuration.

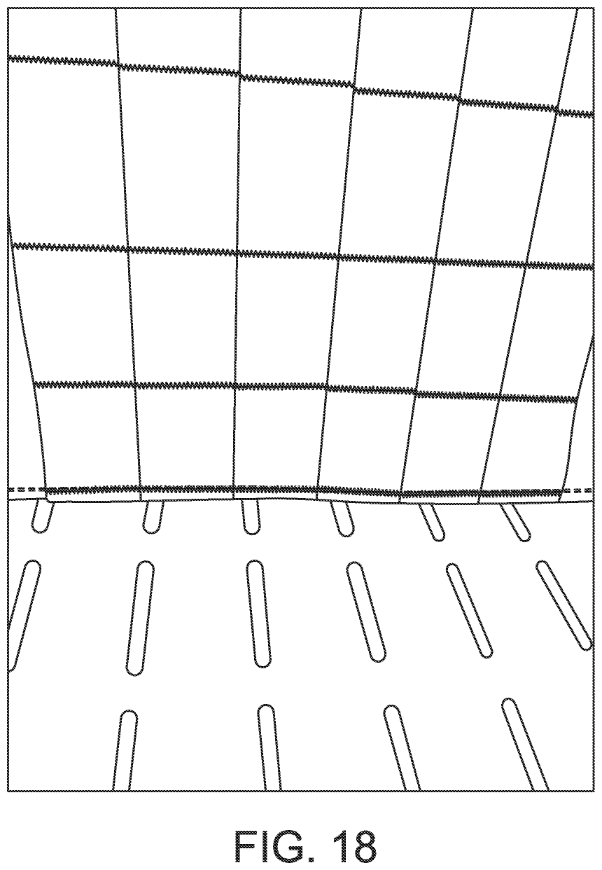

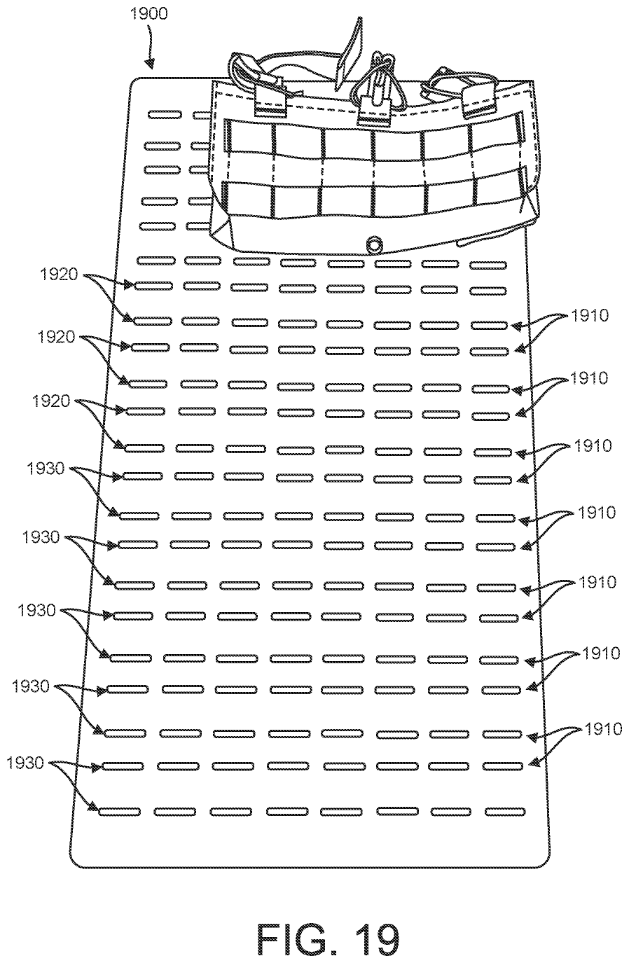

Referring to FIG. 18, the alignment between the spacing of FIG. 14A and the spacing of FIG. 16 is illustrated. As it may be observed, the edge spacings are not aligned so the spacing of the edges which retain the bags of FIG. 14a to the insert are not optimal as illustrated in FIG. 16A.

To provide a more appropriate spacing of the slits of FIG. 14A, it was determined that the spacing between rows of slits should not be consistent along the length of the insert. In other words, the spacing between the rows of slits should be modified in a manner to provide selected sets of edges that are multiples of 1 inch apart, so that the bags may be more properly secured.

Referring to FIG. 19, a modified insert 1900 includes first pairs of slits 1910 that includes a consistent spacing apart from one another. The modified insert 1900 includes second pairs of slits 1920 that includes a consistent spacing apart from one another. Additionally, pairs of slits with consistent spacing that are different the others may be included, if desired. Further the slits 1910, 1920 preferably have a consistent width, suitable for a piece of webbing to be inserted therethrough. The slits 1910, 1920 may be formed in any suitable manner, such as for example, water jet cutter and laser cutter.

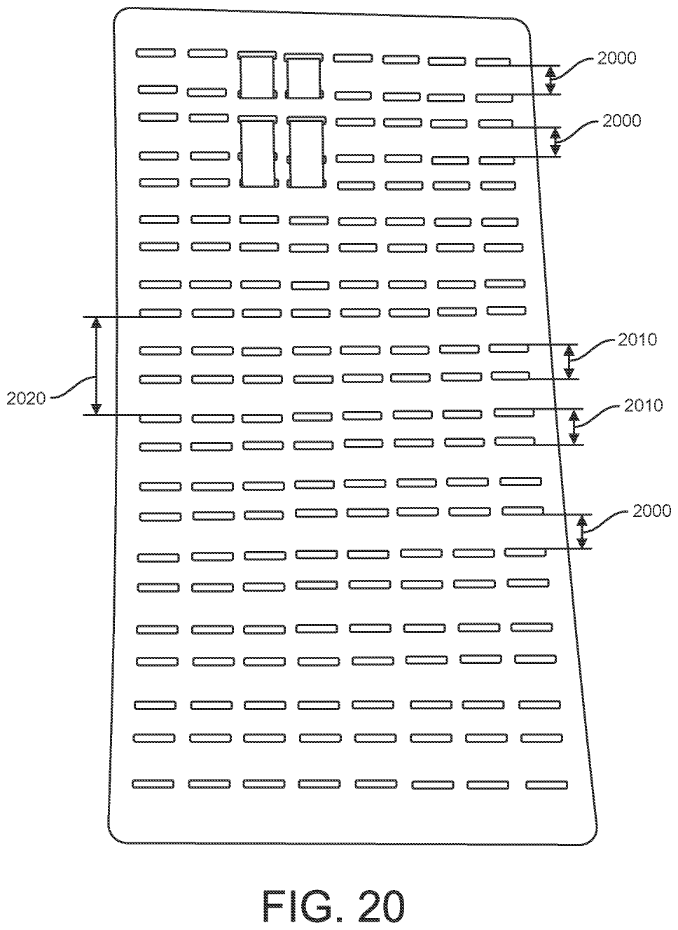

Referring to FIG. 20, the interior edges 2000 between the further spaced apart adjacent interior edges are preferably 1 inch apart (+/− 1/16^{th} of an inch) (e.g., substantially 1 inch). In this manner, for a bag that uses a pair of spaced apart interior edges intended to have a 1 inch spacing, will result in a secure fit for the bag. The spacing between the exterior edges 2010 between the closer spaced apart adjacent exterior edges are preferably 1 inch apart (+/− 1/16^{th} of an inch) (e.g., substantially 1 inch). The slits preferably all have the same width. In this manner, for a bag that uses a pair of spaced apart interior edges intended to have a 2 inch spacing, will result in a substantially secure fit for the bag, albeit the interior edges are not precisely at 2 inches apart. The spacing between the interior edges 2020 between the spaced apart interior edges are preferably 3 inches apart (+/− 1/16^{th} of an inch) (e.g., substantially 3 inches). In another spacing arrangement, the edges may be arranged so that the even number of inches are substantially aligned, with the odd number of inches being slightly different. As it may be observed, by a suitable arrangement of spacing between the edges of the slits, the spacing between the edges does not progressively get out of alignment as the distance increases.

The insert is preferably constructed from any suitable stiff material. In other cases, the insert may be constructed from generally flexible material, such as a tool roll. Preferably, the insert is constructed from SRP material. Preferably, the insert is constructed of a SRP material with a fabric material adhered to the surface thereof. With the fabric material adhered to the SRP material, the additional source of movement of the bags attached thereto is reduced. In addition, if the fabric material is made of a loop material (or hook material), then it is suitable for being detachably engaged with a bag having an opposing hook material (or loop material).

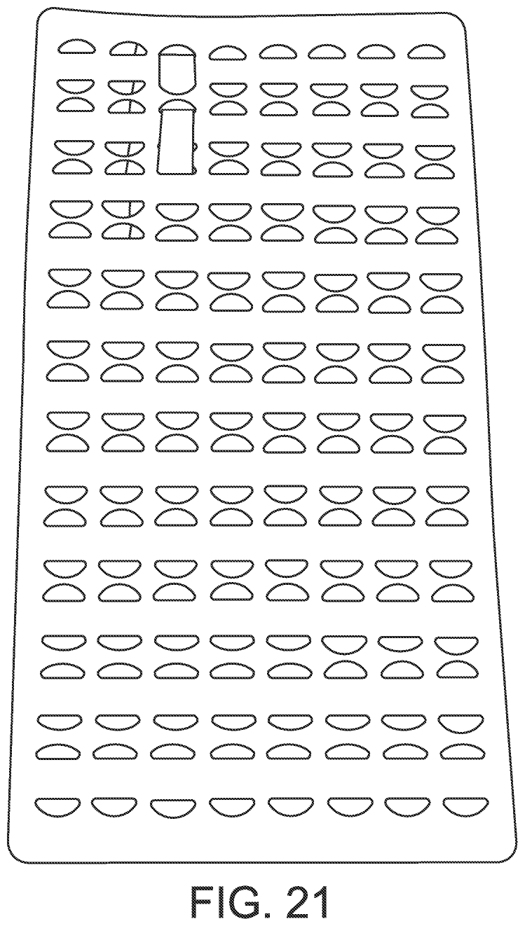

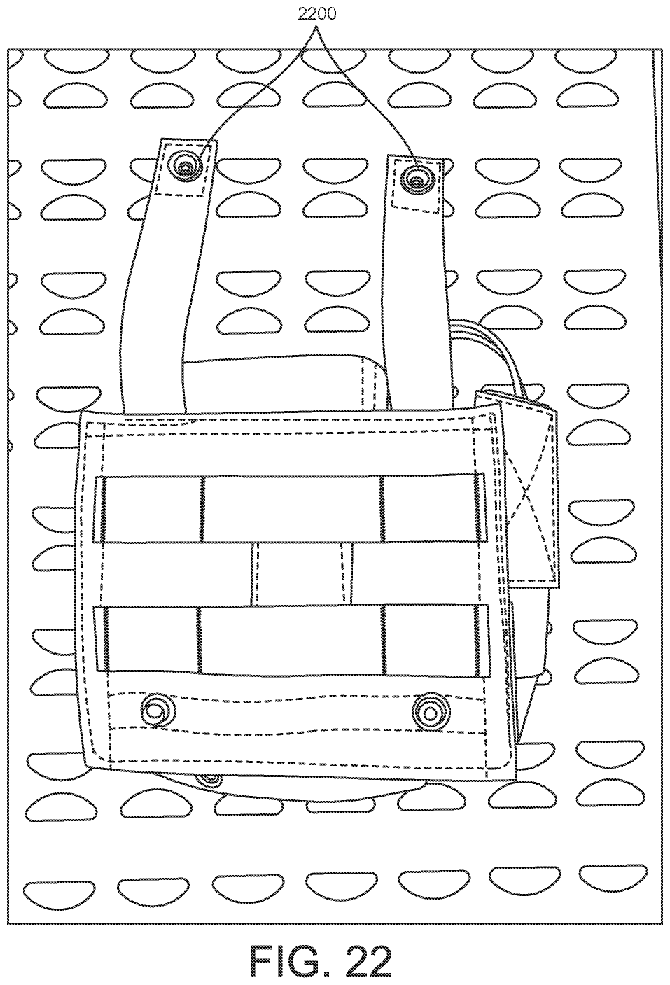

In some cases, the bags may include “snaps” on the ends of the straps. The snaps do not tend to fit through relatively thin slots. Referring to FIG. 21 and to FIG. 22, to accommodate the snaps, the insert may include half-moon shape openings. In this manner, there still remains the straight edges suitable for securing the straps to the bags with the half moon shape openings to accommodate the snaps.

Other shapes for the openings may be used, although preferably the elongate edge of the opening includes a substantially straight edge. Moreover, to decrease weight additional circular and/or oval openings and/or other shaped openings maybe included to remove material. Further, while the grid pattern is shown in the vertical direction, the same pattern may also be included in the horizontal direction.

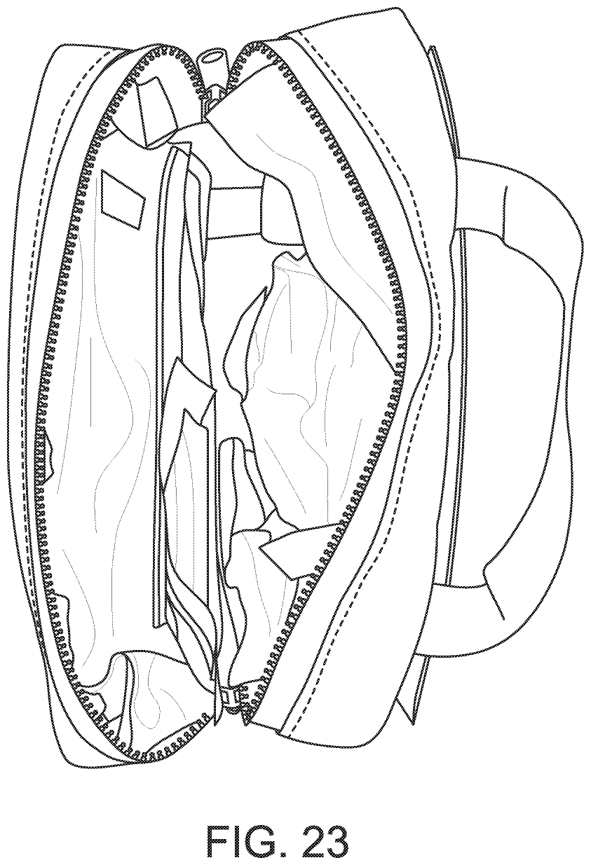

Referring to FIG. 23, a medical pouch is illustrated. Medical supplies go in the pouch which is then closed using a zipper. As it may be observed, the various medical supplies are scattered within the pouch with a somewhat random organization.

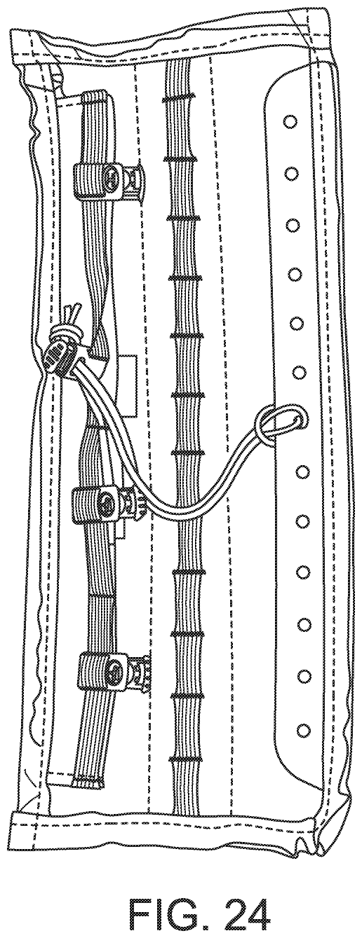

Referring to FIG. 24, another medical pouch is illustrated. Medical supplies go in the pouch and an assortment of medical supplies may be attached to various attachment mechanisms on the exterior of the pouch. As it may be observed, the various medical supplies are scattered on the exterior of the pouch with a somewhat random organization.

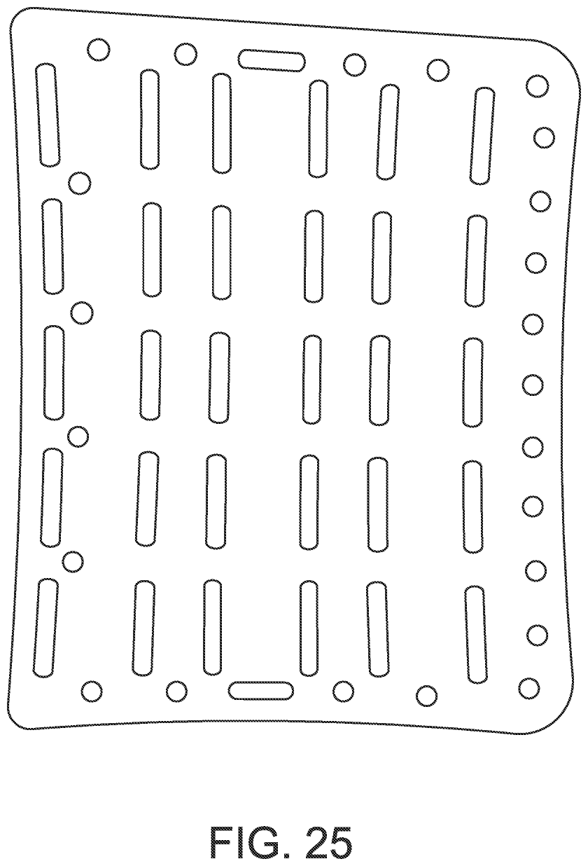

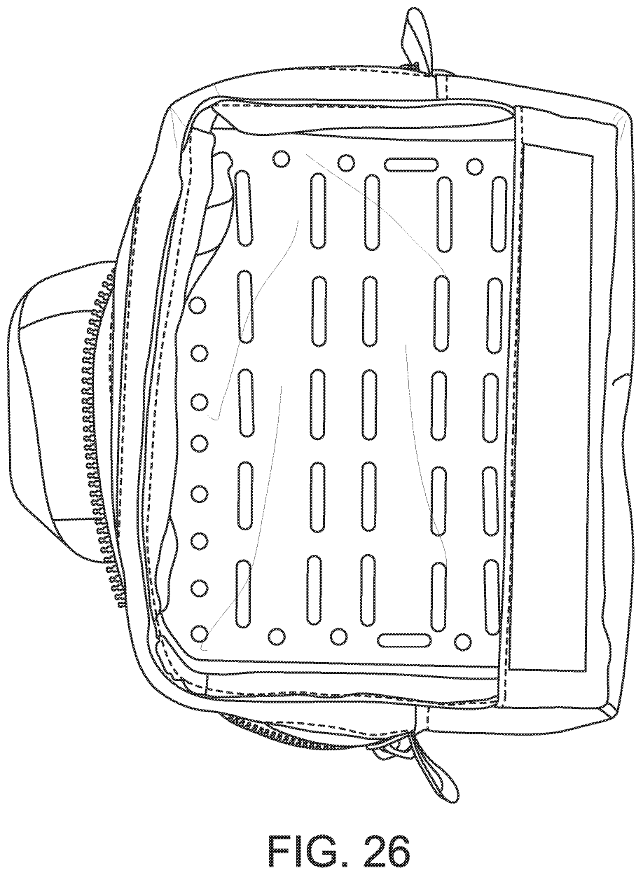

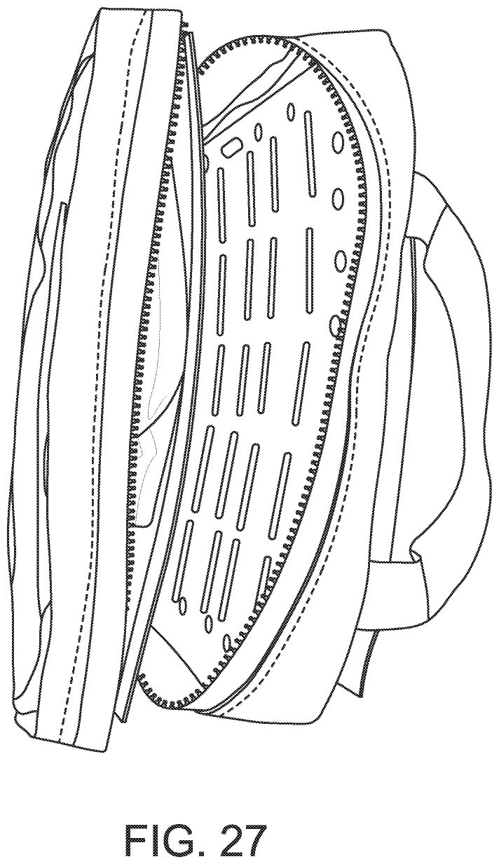

Referring to FIG. 25, an insert 2500 may be sized to fit within a medical pouch, such as the pouch illustrated in FIG. 24. The insert 2500 is similar to the insert illustrated in FIG. 19. Referring to FIG. 26 and FIG. 27, the insert 2500 is illustrated being included within a medical pouch.

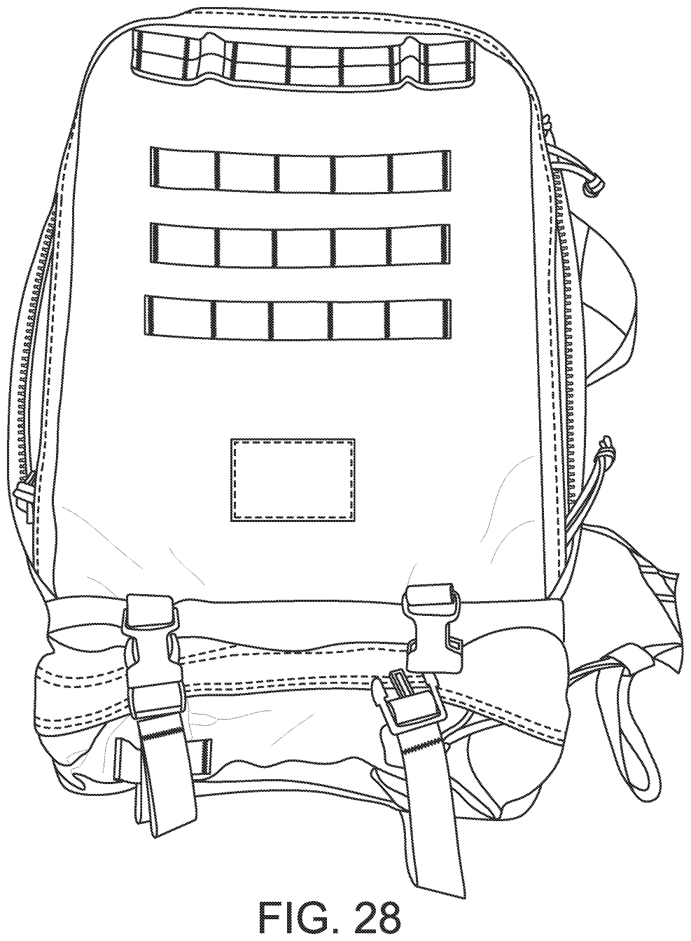

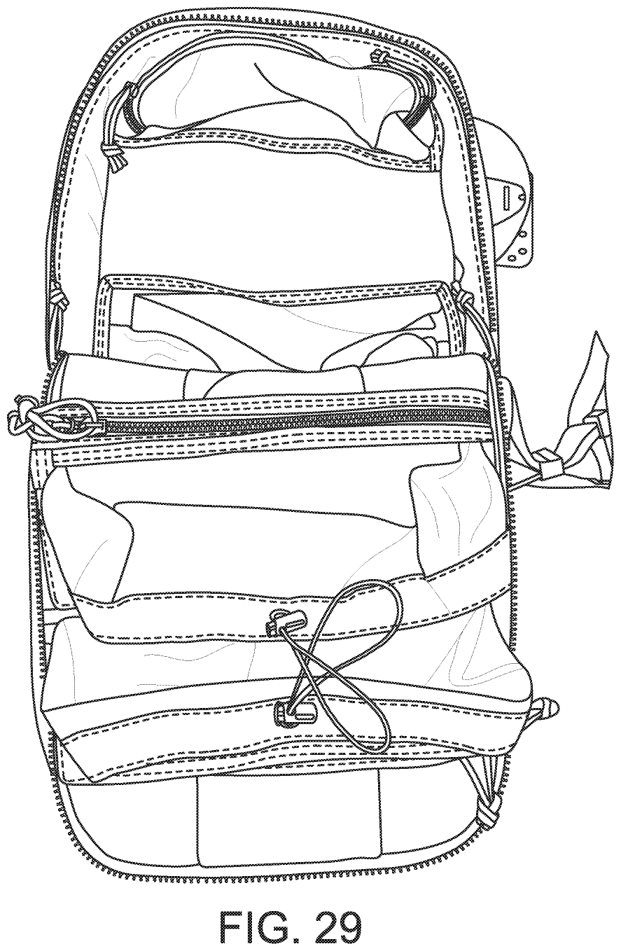

Referring to FIG. 28, a medical backpack that includes a PALS compliant set of webbing secured thereto, together with additional webbing and hook fabric is illustrated. While the exterior of the medical backpack provides a somewhat organized manner of storing bags and other items thereon, referring to FIG. 29, the interior of the medical backpack includes a multitude of different compartments. While the compartments provide a manner of organizing medical supplies, it is time consuming to determine which supplies have been used after a mission, or whether an existing medical bag has a complete set of medical supplies, or whether one or more medical supplies are missing.

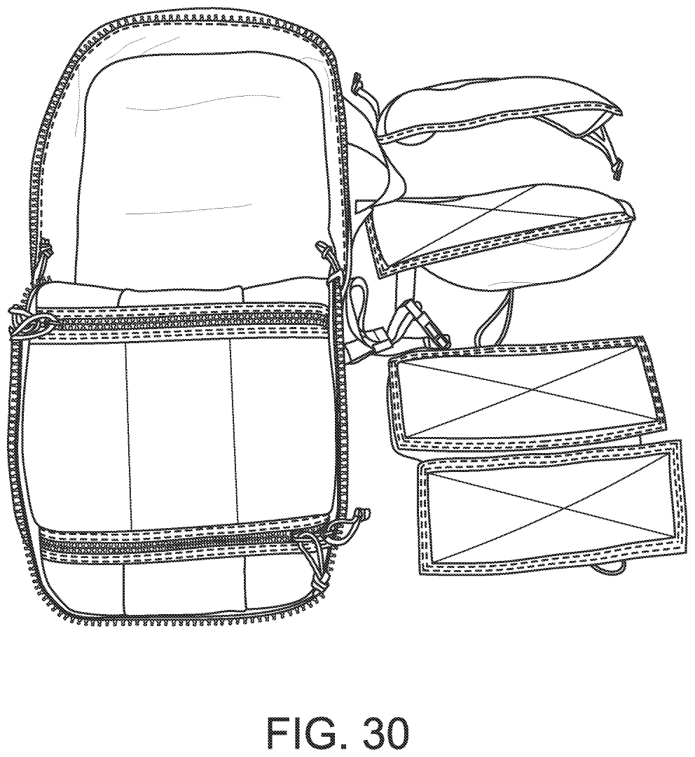

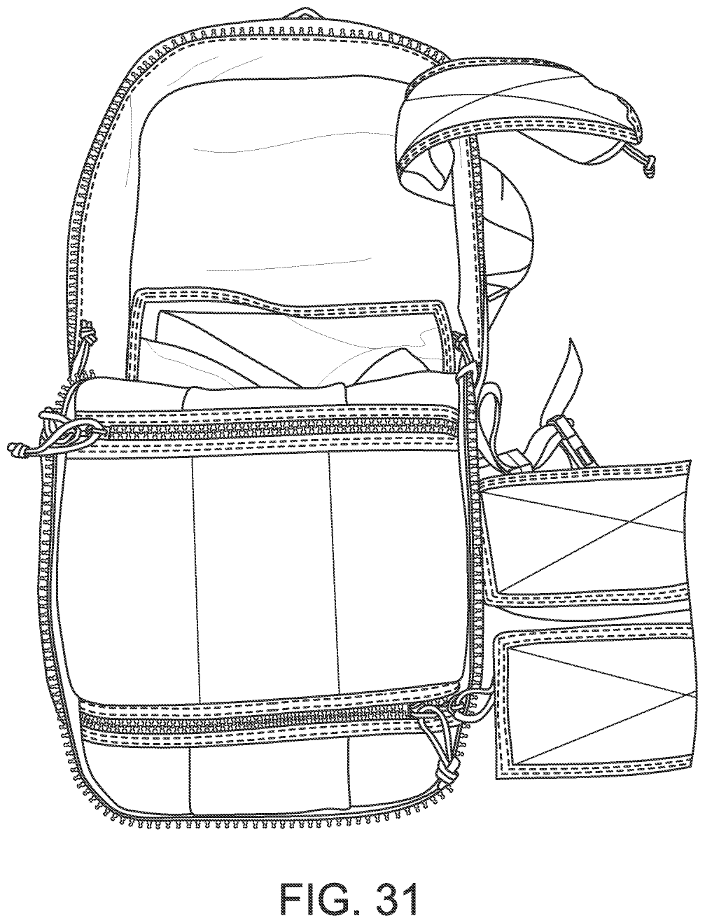

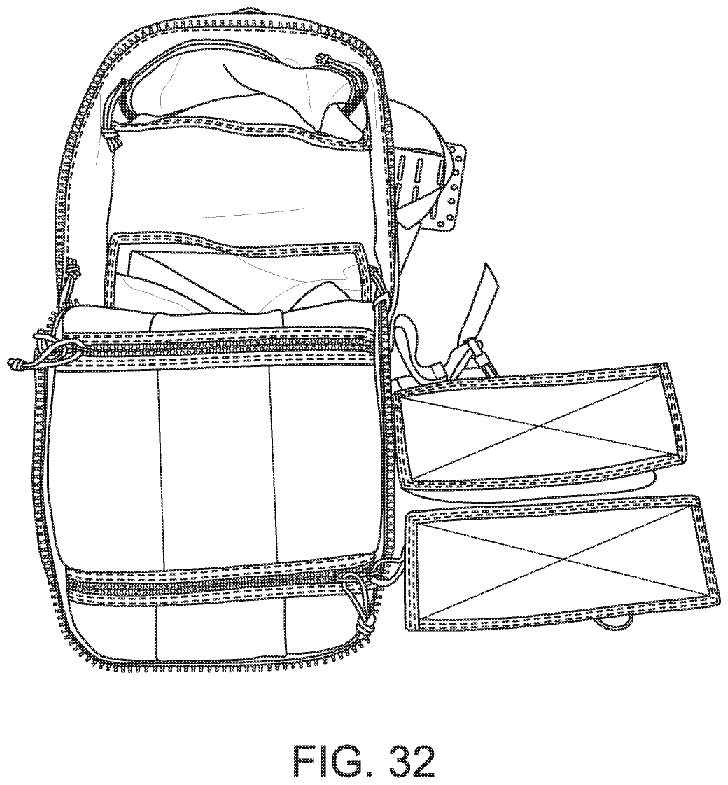

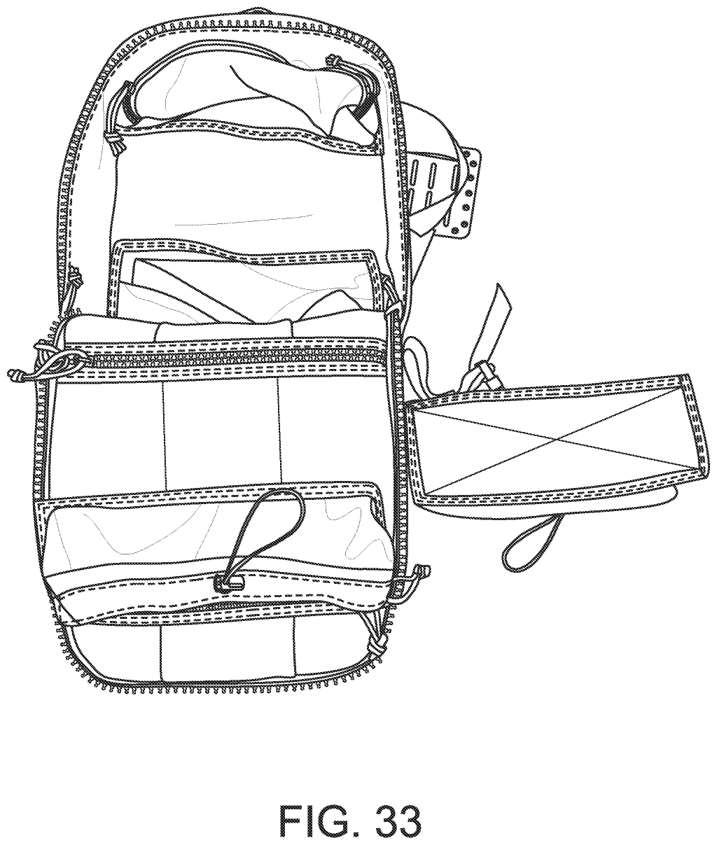

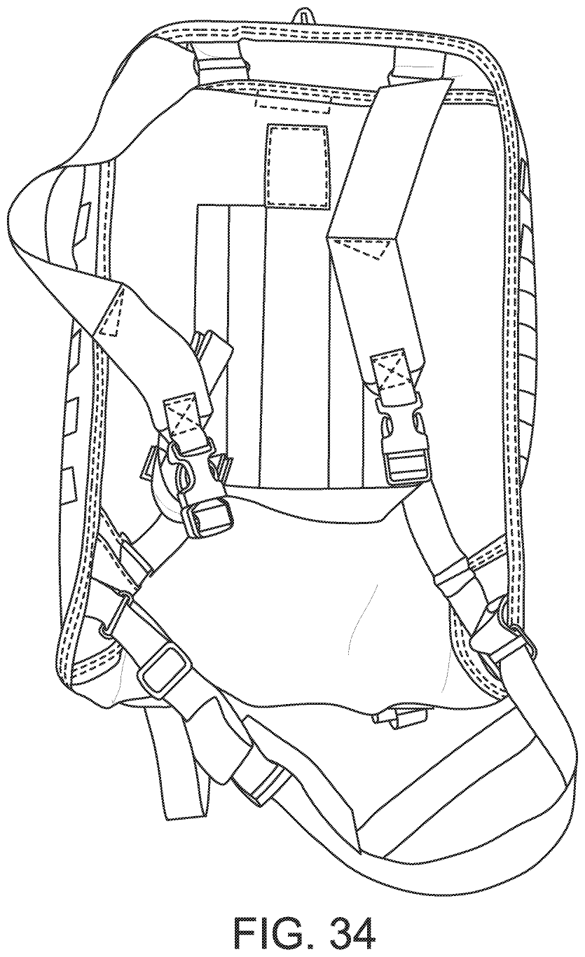

Referring to FIG. 30, a medical backpack is illustrated that includes four interior pouches that are suitable to be attached with hook and loop fabric. Referring to FIG. 31, the medical backpack is illustrated with one of the interior pouches attached and another of the interior pouches partially attached. Referring to FIG. 32, the medical backpack is illustrated with two of the interior pouches attached and the other two of the interior pouches not attached. Referring to FIG. 33, the medical backpack is illustrated with three of the interior pouches attached and the other of the interior pouches not attached. Referring to FIG. 34, the front side of the medical backpack is illustrated. While the medical backpack of FIG. 30 has fewer pouches than the medical backpack of FIG. 28, there remains a substantial number of pouches that need to be accounted for and checked.

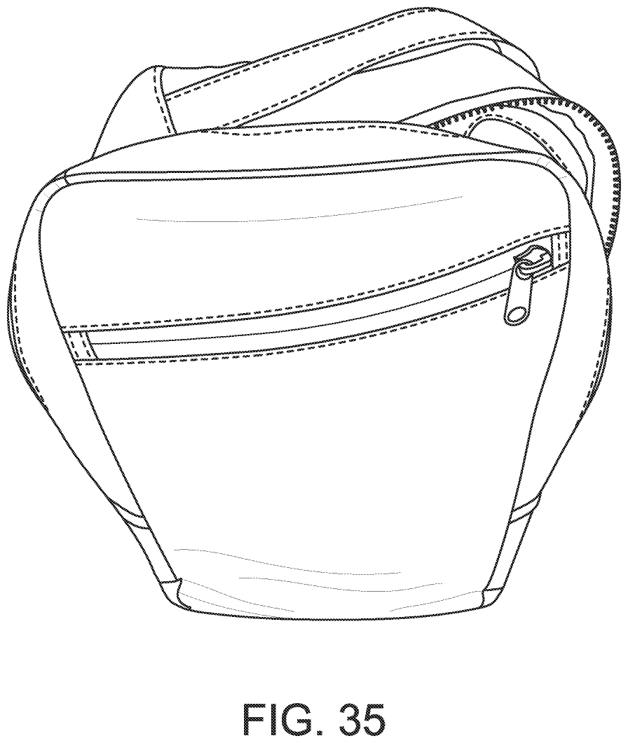

Referring to FIG. 35, a simplified medical backpack is illustrated. The medical backpack of FIG. 35 may include PALS and/or hook/loop fabric and/or webbing on the interior and/or exterior thereof, as desired.

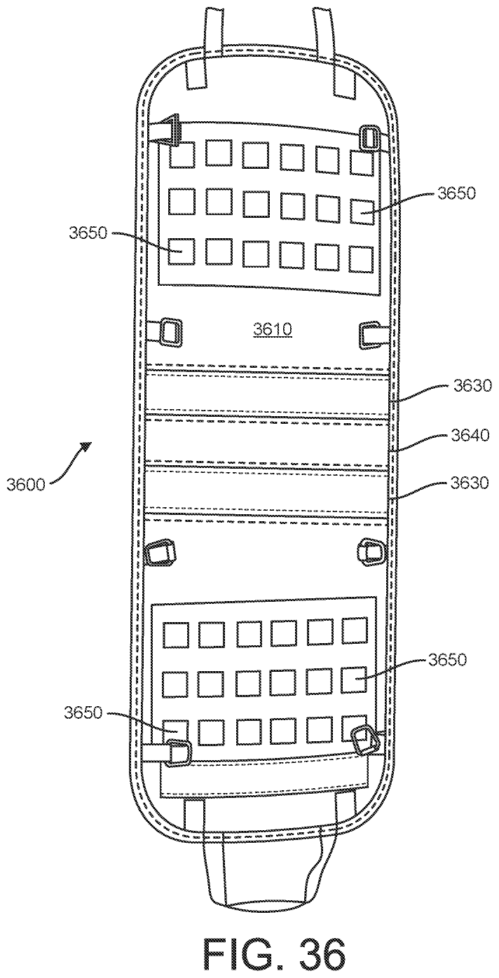

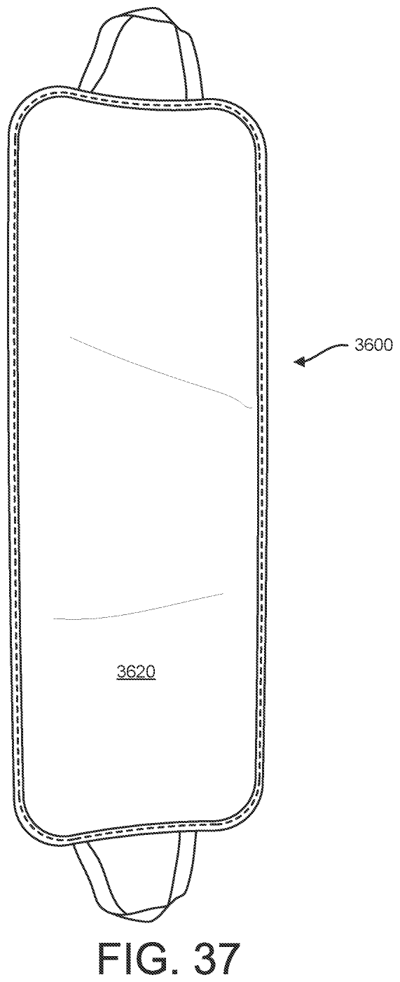

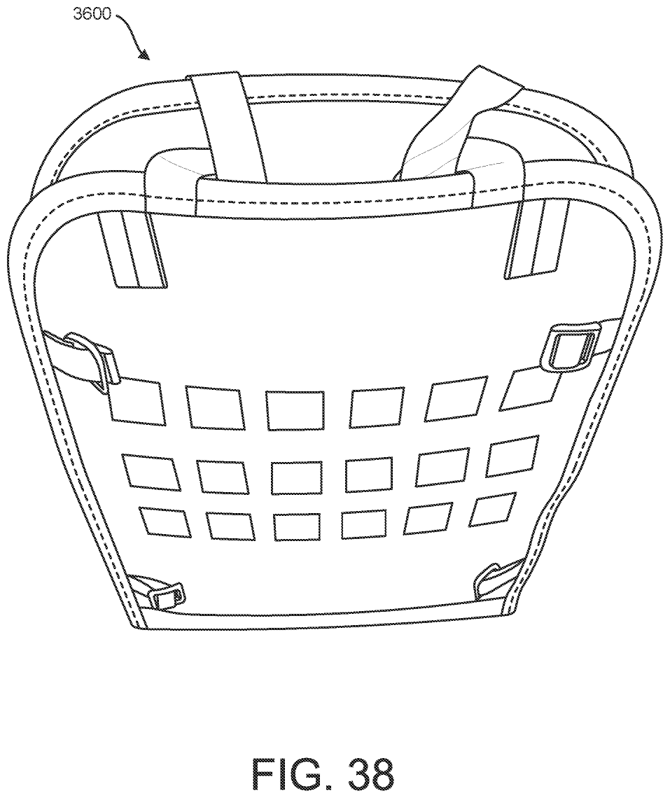

Referring to FIG. 36 and FIG. 37, an insert 3600 includes a panel 3610 that is preferably formed from a SRP material, although other materials may be used, as desired. The insert 3600 may include a fabric 3620 adhered to one or both faces of the panel 3610, in such a manner that the fabric 3620 does not move with respect to the corresponding face of the panel 3610. The panel 3610 and the fabric 3620 may form a pair of hinges 3630, preferably with a central panel section 3640 therebetween. The panel 3610 may be constructed with a set of openings defined therein 3650, such as compliant with the PALS configuration. The panel 3610 may further include hook and/or loop fabric thereon, if desired. The insert 3600 may be configured with all of the desired bags secured thereto, such as all the suitable bags for a particular medical environment, which is in an open manner where the existence of each bag is readily identified. Referring to FIG. 38, after the insert 3600 is configured with all of the desired bags, or otherwise, secured thereto the insert 3600 may be configured in a “U” shape by folding along the hinges 3630. The insert 3600 is readily placed within the simplified medical backpack of FIG. 35.

A plurality of different inserts 3600 may be pre-configured with a desired set of bags detachably secured thereto. For example, one set of inserts may be configured for a helicopter medial service, another set of inserts may be configured for a special forces team, another set of inserts may be configured for a medical surgical group, or otherwise. Each of the sets of inserts may be labeled, for ease of identification and distinguishing from other types of sets of inserts. The labels may be, for example, in a textual, a graphical, a QR code, and/or a bar code format. Also, a RFID tag (passive or active) may be embedded in the composite structure.

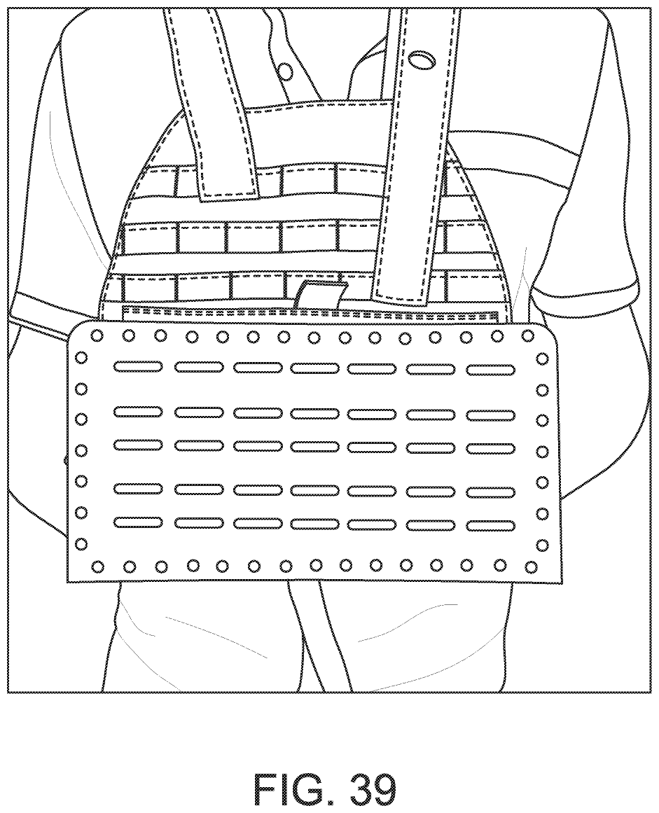

Referring to FIG. 39, a panel (e.g., SRP) may be configured to be supported by the front chest of a user. In this manner, the user may support bags and other items on the panel using the PALS openings.

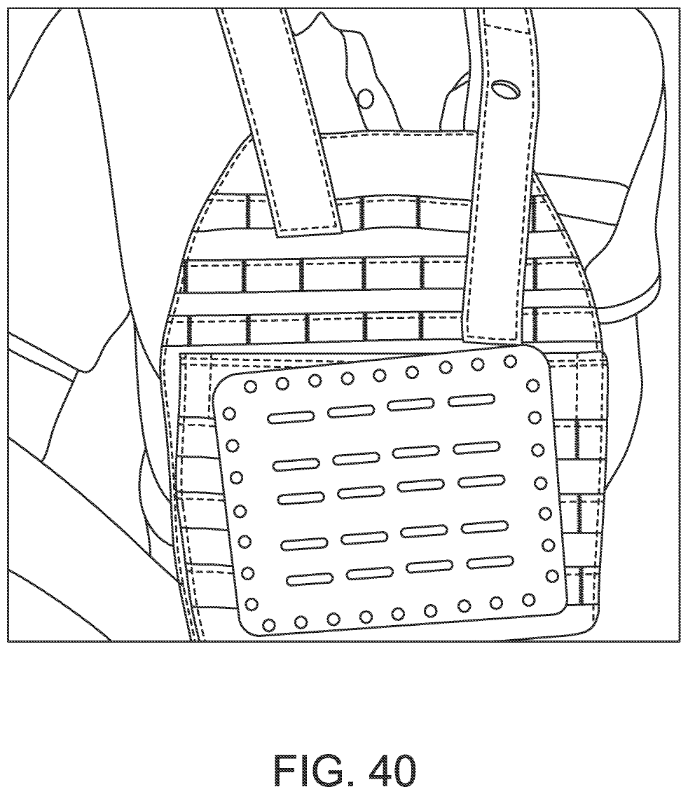

Referring to FIG. 40, a panel (e.g., SRP) preferably with a hook and/or loop fabric adhered thereto, may be configured to be supported by the front chest of a user. In this manner, the user may support bags and other items on the panel using the PALS openings.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A fabric material comprising:
(a) a self-reinforced polymer composite material constructed from a thermoplastic polymer having highly oriented fiber reinforcement materials in a matrix of said thermoplastic polymer;
(b) a textile material adhered in a face-to-face-manner with a surface of said self-reinforced polymer composite material with an adhesive having a chemical base that is the same as the thermoplastic polymer.

2. The fabric material of claim 1 wherein said thermoplastic polymer is one of a polyamide, a polyethylene, a polyethylene terephthalate, an ultra-high density polyethylene, an ultra-high density an ultra-high-molecular weight polyethylene, an aramid, and a polypropylene.

3. The fabric material of claim 1 wherein said composite material is a woven thermoplastic composite material of a tape yarn construction.

4. The fabric material of claim 1 wherein said composite material is a woven thermoplastic composite material of a crystal extrusion.

5. The fabric material of claim 3 wherein said tape yarn construction has multiple layers with an outer layer having a melt point at a lower temperature than an inner material.

6. The fabric material of claim 5 wherein said tape yarn having a tensile modulus of 10 GPa or more.

7. The fabric material of claim 6 wherein said tape yarn having a shrinkage at 130 degrees Celsius of 6% or less.

8. The fabric material of claim 7 wherein said tape yarn having a sealing temperature of 120 degrees Celsius or more.

9. The fabric material of claim 8 wherein said tape yarn having a denier of 900 or more.

10. The fabric material of claim 9 wherein self-reinforced polymer composite material having a density of greater than 800 kg/m3.

11. The fabric material of claim 10 wherein self-reinforced polymer composite material having a tensile modulus GPA between 3 and 35.

12. The fabric material of claim 11 wherein self-reinforced polymer composite material having a tensile strength MPa greater than 100 and less than 400.

13. The fabric material of claim 1 wherein said self-reinforced polymer composite material has a surface that is mechanically roughened.

14. The fabric material of claim 1 wherein said self-reinforced polymer composite material has a surface that is chemically treated in a manner increasing its surface energy.

15. The fabric material of claim 1 wherein said self-reinforced polymer composite material has a surface has a corona treatment.

16. The fabric material of claim 1 wherein said adhesive is in the form of a film with the same type of adhesive on both side of the film.

17. The fabric material of claim 1 wherein said adhesive is in the form of a film with different types of adhesive on each side of the film.
